(19) United States
(12) Patent Application Publication
(10) Pub. No.: US 2012/0024956 A1
(43) Pub. Date: Feb. 2, 2012

(54) QR CODE HAVING HIDDEN CODES AND METHODS OF FORMING AND IDENTIFYING THE HIDDEN CODES

(75) Inventor: YU-HSIANG CHEN, Tu Cheng (TW)

(73) Assignee: Cheng Uei Precision Industry Co., LTD, Tu Cheng City (TW)

(21) Appl. No.: 12/848,934

(22) Filed: Aug. 2, 2010

(51) Int. Cl. G06K 19/06; G06K 7/12

(52) U.S. Cl. 235/469; 235/494

(57) ABSTRACT

Disclosed are a QR (Quick Response) code having hidden codes and methods for forming and identifying the hidden codes. The QR code comprises a plurality of square colored message unit blocks for computer systems identification and arranged without gaps according to a predetermined rule. The hidden codes are located in the colored message unit blocks, wherein the chrominance of the hidden codes is different from the chrominance of the colored message unit blocks to achieve the objective of anti-counterfeiting and hidden, thereby ensuring the colored message unit blocks that are not easy to be discovered and achieves a higher anti-counterfeiting and hidden function.

### TECHNICAL FIELD OF THE INVENTION

The present invention relates to a two-dimension barcode, and especially to a QR (Quick Response) code having hidden codes and methods of forming and identifying the hidden codes.

### BACKGROUND OF THE INVENTION

A two-dimension barcode is a new technology of information storage and transmission, widely used for product identification, security and anti-counterfeiting, E-commerce and so on. The two-dimension barcode records data information with particular geometric patterns distributed in two-dimensional directions via black and white graphic symbols. A concept of logical basis “0”, “1” bit stream adopted in computer systems is utilized to form graphic symbols that correspond to binary representation of text and numerical information. The graphic symbols can be read by an image input device or a photoelectric scanning device to achieve automatic information processing.

International standards of the two-dimension barcode include PDF417, Data Matrix, Maxi Code, and QR (Quick Response) Code, among which QR code is most widely used. Referring to FIG. 1, the QR code 10′ of the prior art is a square, and the QR code 10′ includes a plurality of message unit blocks composed of black blocks 11′ and white blocks 12′. The black blocks 11′ and the white blocks 12′ respectively indicate digits “0” and “1” in binary numerical system that encodes the QR code. The QR code shows an advantage of high-speed and all-direction (360 degrees) accessibility, and is capable of representation of Chinese characters.

However, with the growth of the QR code technology and the promotion of applicable fields, methods of coding and decoding the QR code are well known. In the fields of anti-counterfeiting or confidentiality, the QR codes are usually required to tag an additional hidden code to represent the information of anti-counterfeiting or encryption, and there is no specific solution currently to resolve the afore-mentioned method. Therefore, a QR code having hidden codes and methods of forming and identifying the hidden codes are urgently needed to overcome the aforesaid drawbacks.

### SUMMARY OF THE INVENTION

One objective of the present invention is to provide a QR code having hidden codes, which the hidden codes in the QR code cannot easily be discovered and has a higher anti-counterfeiting and hidden function.

Another objective of the present invention is to provide a method of forming hidden codes, which the hidden codes in the QR code cannot easily be discovered and has a higher anti-counterfeiting and hidden function.

Still another objective of the present invention is to provide a method of identifying hidden codes that does not affect the original method of reading the QR codes, and can rapidly and accurately identify the hidden codes located in the QR code.

To achieve the foregoing objectives, the present invention provides a QR code having hidden codes. The QR code comprises a plurality of colored message unit blocks which are arranged without gaps according to a predetermined rule. The hidden codes are located in the colored message unit blocks, wherein the chrominance of the hidden codes is different from the chrominance of the colored message unit blocks.

To achieve the foregoing objectives, the present invention provides a method of forming hidden codes, the method comprising the steps of: providing a QR code, the QR code comprising a plurality of square colored message unit blocks for computer systems identification and arranged without gaps according to a predetermined rule; and setting a plurality of smaller colored message unit blocks for computer systems identification in the colored message unit blocks to form the hidden codes, wherein the chrominance of the smaller colored message unit blocks is different from the chrominance of the colored message unit blocks.

To achieve the foregoing objectives, the present invention provides a method of identifying hidden codes, the method comprises the steps of: switching a resolution of a camera and selecting the same zone within each of the colored message unit blocks of a QR code to acquire the image information in the zones by using a high resolution and a low resolution; analyzing a mean value of pixels of the acquired image information on each of the colored message unit blocks; and setting a threshold to identify the hidden codes, wherein the mean value which is lower than the threshold is assessed as 0, and greater than the threshold value is assessed as 1.

As mentioned above, according to the QR code having the hidden codes of the present invention, the hidden codes located in the QR code does not affect the original method of reading the QR code. The hidden codes are located in the colored message unit blocks via the chrominance of the hidden codes being different from the chrominance of the colored message unit blocks to achieve the objective of anti-counterfeiting and hidden, thereby not being easy to be discovered and easily achieving a higher anti-counterfeiting and hidden function. Correspondingly, according to the method of forming hidden codes of the present invention, the hidden codes are located in the colored message unit blocks via the chrominance of the hidden codes being different from the chrominance of the colored message unit blocks to achieve the objective of security and anti-counterfeiting. The method is easy to achieve a higher anti-counterfeiting and a hidden function, and does not affect the original method of reading the QR codes. The method of identifying hidden codes of the present invention, which is based on not affecting the original method of reading the QR code, utilizes the camera with the high and low resolution and the appropriate threshold to achieve rapid and accurate identification of the hidden codes of the QR code.

### BRIEF DESCRIPTION OF THE DRAWINGS

FIG. 1 is a schematic top view illustrating a QR code according to the prior art.

FIG. 2 is a schematic top view illustrating a QR code having hidden codes according to the present invent.

FIG. 3 is a schematic top view illustrating a hidden code located in a colored message unit block.

FIG. 4 is a flow chart illustrating a method of forming the hidden codes according to the present invention.

FIG. 5 is a flow chart illustrating a method of identifying the hidden codes according to the present invention.

FIG. 6 is a simulation diagram illustrating the A zone of FIG. 2 in a 7×7 array under the mode of a resolution 2M(1600×1200).

FIG. 7 is a simulation diagram illustrating the A zone of FIG. 2 in a 14×14 array under the mode of the resolution 2M(1600×1200).

FIG. 8 is a simulation diagram illustrating the A zone of FIG. 2 in a 7×7 array under the mode of a resolution VGA (640×480).

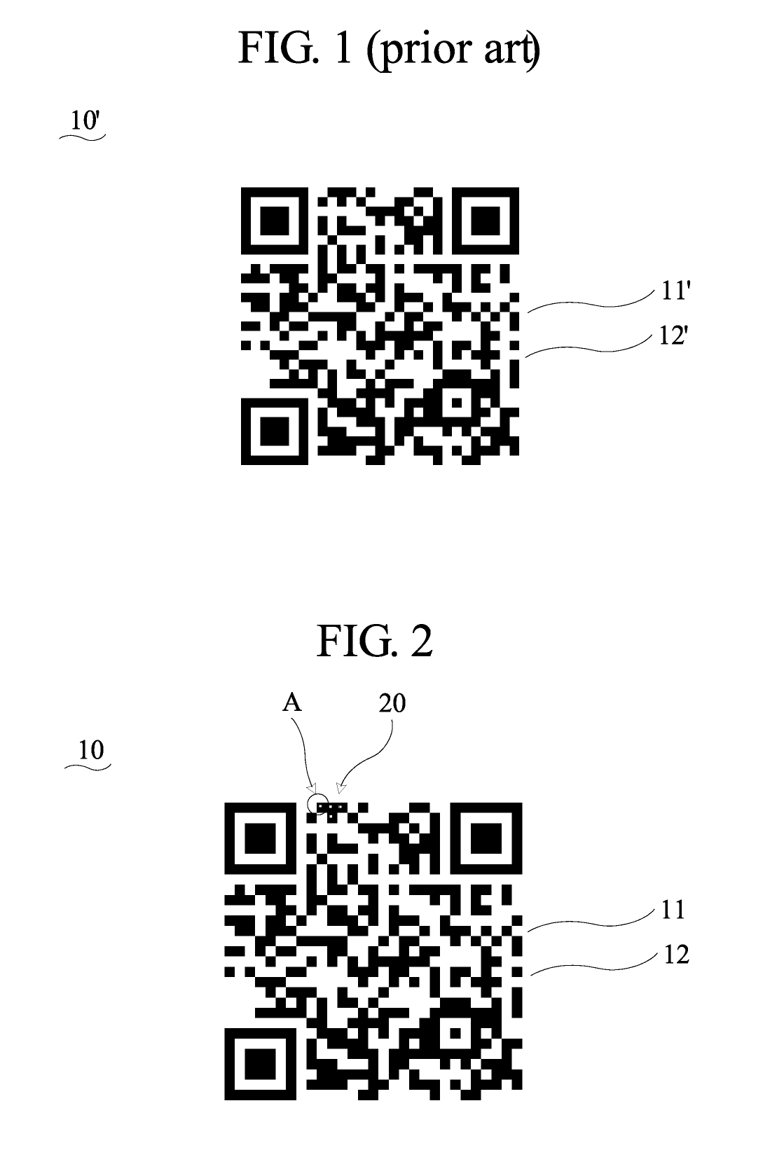

### DETAILED DESCRIPTION OF THE INVENTION

Reference will now be made in detail to the present preferred embodiments of the invention, examples of which are illustrated in the accompanying drawings.

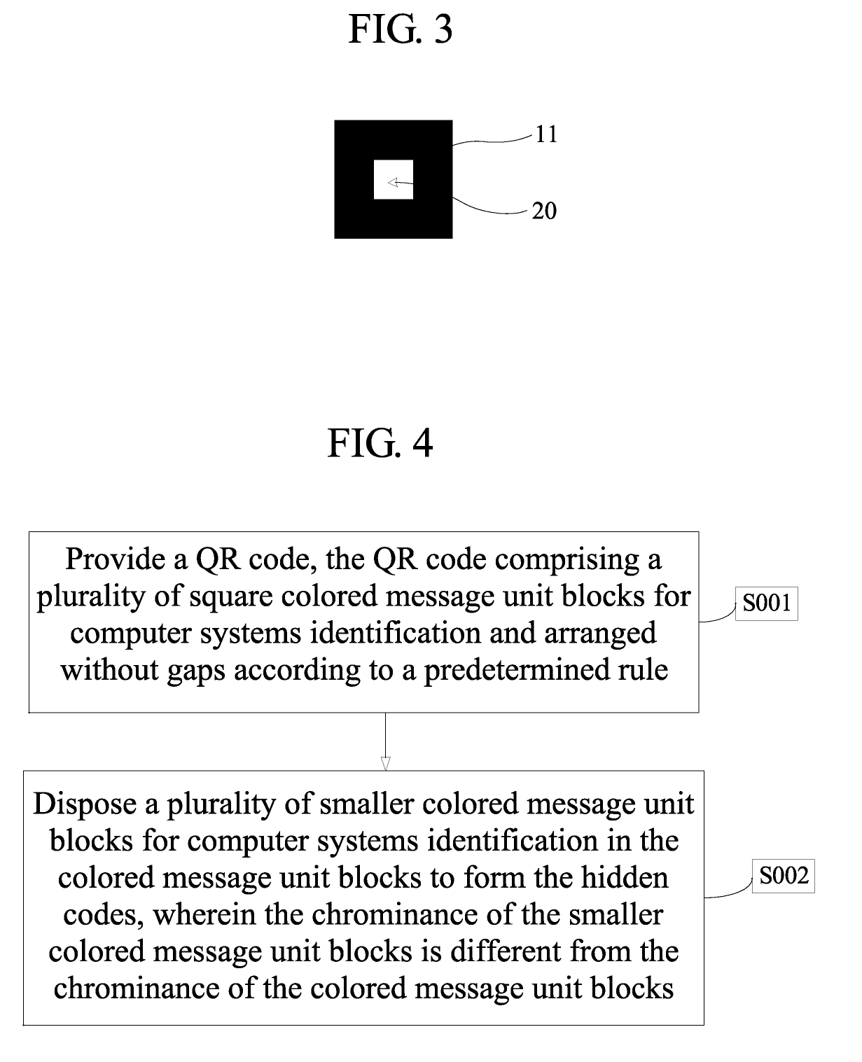

Referring to FIG. 2 and FIG. 3, according to one embodiment of the present invention, the square QR code 10 is composed of a plurality of white unit blocks 12 and black unit blocks 11, which are also square, arranged without gaps according to a predetermined rule. The colored message unit blocks of the QR code 10 consist of the white unit block 12 or black unit blocks 11. The white unit blocks 12 and black unit blocks 11 respectively represent “0” and “1” of binary digits. Information can be encoded as the QR code 10 by the binary digits, and the information can be decoded via image identification to acquire the related information.

Referring to FIG. 4, the method of forming hidden codes according to the present invent begins at step S001.

At step S001, a QR code is provided, which the QR code comprises a plurality of square colored message unit blocks for computer systems identification and arranged without gaps according to a predetermined rule.

At step S002, a plurality of smaller colored message unit blocks are disposed for computer systems identification in the colored message unit blocks to form the hidden codes, wherein the chrominance of the smaller colored message unit blocks is different from the chrominance of the colored message unit blocks.

Referring back to FIG. 3, specifically, the square hidden codes 20 are located at the center part of the colored message unit blocks of the QR code 10, and the area of the hidden code 20 is one-ninth of the area of the colored message unit block of the QR code 10. The hidden code 20 with a minimum pixel is disposed in the appropriate colored message unit block as desired. Specifically, the colored message unit blocks comprise a plurality of white unit blocks or a plurality of black unit blocks, which are correspondingly insert in the colored message unit blocks to from a high contrast due to the different chrominance. The hidden codes 20 are inserted in the QR code 10, that is, the black unit blocks or the white unit blocks with a high contrast are inserted into the colored message unit blocks. Accordingly, the combinations of the inserted hidden codes 20 and the colored message unit blocks form little black blocks or little white blacks to insert into the QR code 10 without affecting the original method of reading the QR code 10. This solution is simple and easy to implement. Furthermore, the hidden codes 20 are not easy to be discovered by the naked eye, wherein the hidden codes 20 can be identified via a high and resolution analysis with a set threshold. Thus, the QR code 10 has a higher anti-counterfeiting and hidden function.

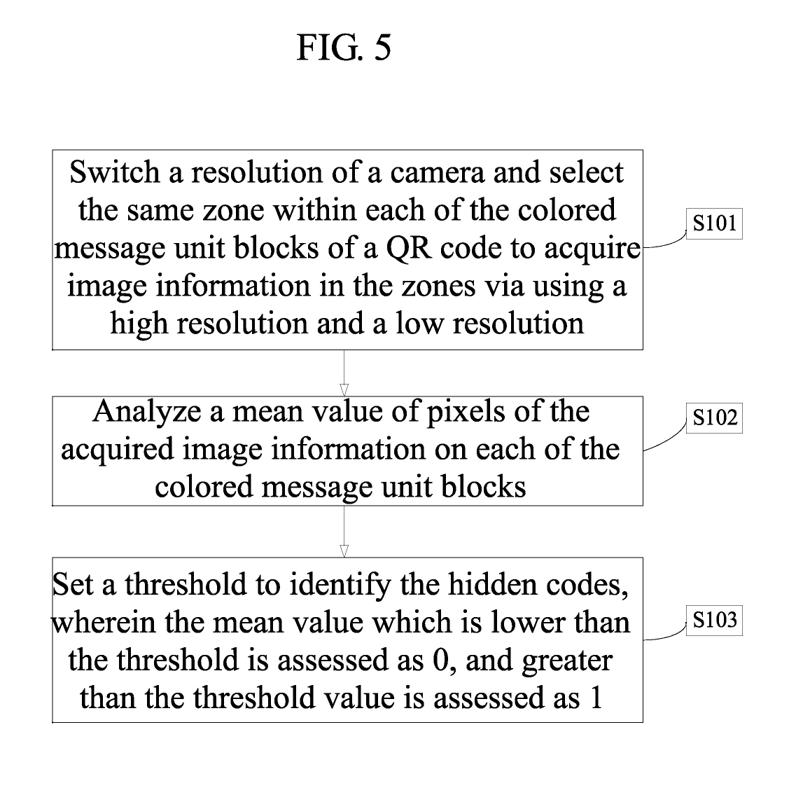

Referring to FIG. 5, the method of identifying hidden codes according to the present invent begins at step S101.

At step S101, a resolution of a camera is switched and selected the same zone within each of the colored message unit blocks of a QR code to acquire image information in the zones via using a high resolution and a low resolution.

At step S102, a mean value of pixels of the acquired image information is analyzed on each of the colored message unit blocks.

At step S103, a threshold is set to identify the hidden codes, wherein the mean value which is lower than the threshold is assessed as 0, and is greater than the threshold value is assessed as 1.

The camera has an image module capable of switching to a high and low resolutions. In the steps of identifying the hidden codes, if the mean values of each the colored message unit block are analyzed on n×n array pixels of the center under the low resolution, the mean values are also analyzed on n×n array pixels of the center under the high resolution. The appropriate threshold can be selected by a calibration of the camera. For example, if the threshold is set as 25 and the chrominance mean value of the pixels of a block is greater than or equal to 25, the block is assessed as “1”. If that is less than 25, the block is assessed as “0”.

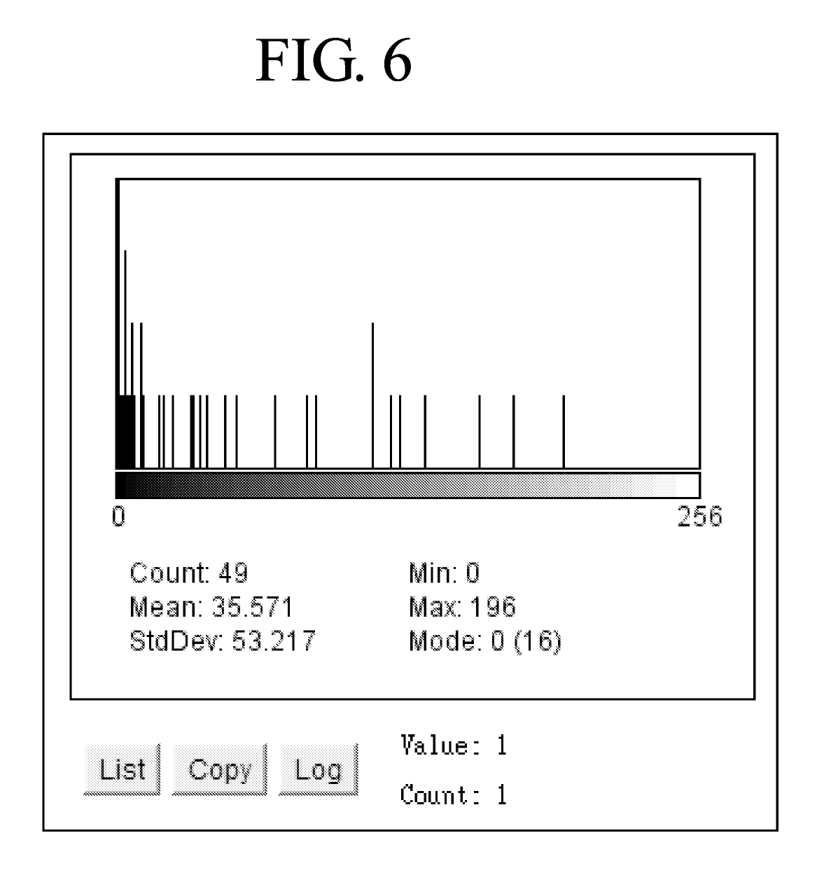

Referring to FIG. 6 to FIG. 8, a Count parameter in the figure indicates calculated pixel points; a Min parameter indicates the minimum chrominance in the calculated pixel points; a Max parameter indicates the maximum chrominance in the calculated pixel points; a Mean parameter indicates the mean value; a StdDev parameter indicates statistical standard deviation; a Mode parameter indicates mode (i.e., the most frequent value, 0 to 256 of the values respectively indicate the chrominance correspondingly from white to black, where 0 and 256 respectively indicate the most black and the most white). Analyzing the A zone of FIG. 2 in a 7×7 array on the center under the mode of a high resolution 2M (1600×1200) obtains the simulation diagram as shown in FIG. 6. The Count parameter is 49 points; the Min parameter is 0; the Max parameter is 196; the Mean parameter is 35; the StdDev parameter is 53; the value of the Mode parameter is 0 with a total 16 times. Due to the Mean parameter being 35 (35>25), the block, which is analyzed, is assessed as 1.

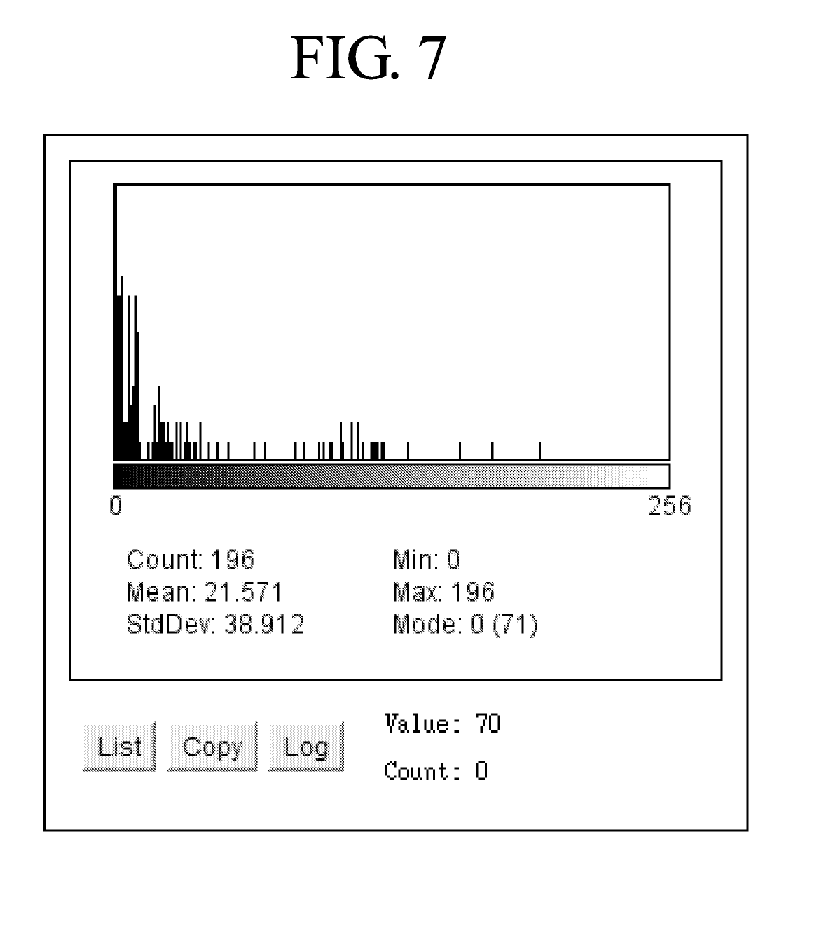

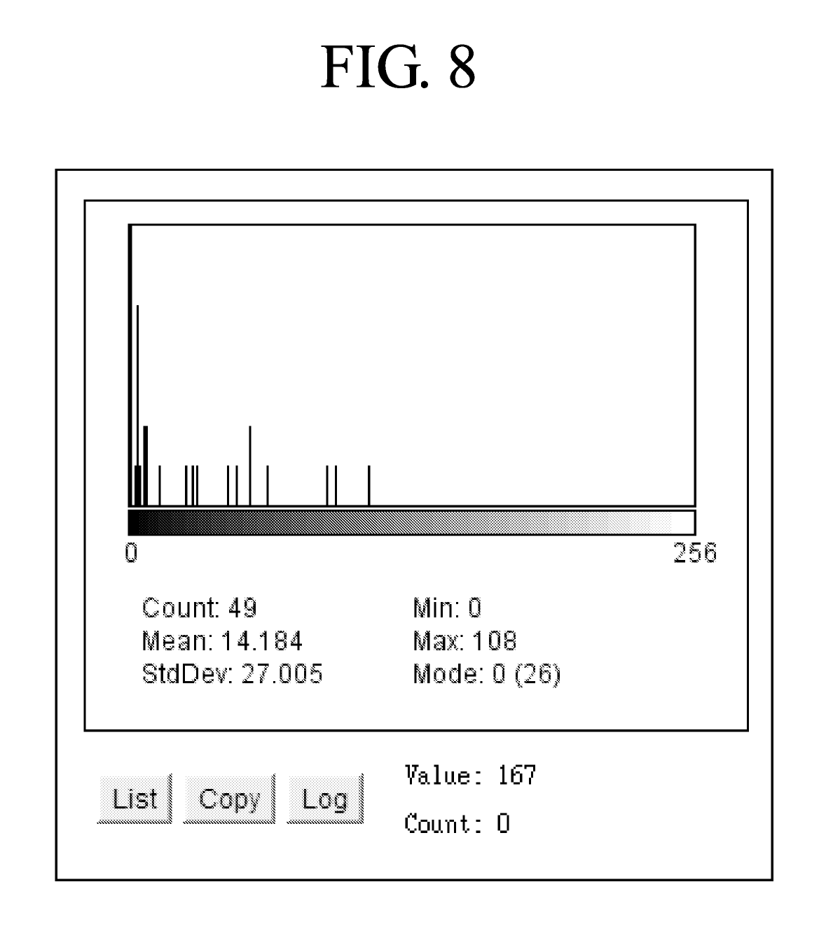

Similarly, analyzing the A zone of FIG. 2 in a 14×14 array under the mode of a high resolution 2M(1600×1200) obtains the simulation diagram as shown in FIG. 7. The Mean parameter is 21. Due to the Mean parameter being 21 (21<25), the block, which is analyzed, is assessed as 0. In addition, Analyzing the A zone of FIG. 2 in a 7×7 array under the mode of a low resolution VGA(640×480) obtains the simulation diagram as shown in FIG. 8. The Mean parameter is 14. Due to the Mean parameter being 14 (14<25), the block which is analyzed, is assessed as 0. Therefore, a different code can be distinguished by switching the high/low resolution to achieve a function of the hidden code. One-ninth the size of the hidden codes 20, which are inserted in particular information via encoding, can be identified whether the hidden code 20 is inserted and obtained the information of the hidden code 20 via the different threshold.

As mentioned above, according to the QR code 10 having the hidden codes 20 of the present invention, the hidden codes 20 located in the QR code 10 does not affect the original method of reading the QR code 10. The hidden codes 20 are located in the colored message unit blocks of via the chrominance of the hidden codes being different from the chrominance of the colored message unit blocks to achieve the objective of security and anti-counterfeiting, thereby not being easy to be discovered and easily achieving a higher anti-counterfeiting and hidden function. Correspondingly, according to the method of forming hidden codes 20 of the present invention, the hidden codes 20 are located in the colored message unit blocks via the chrominance of the hidden codes 20 being different from the chrominance of the colored message unit blocks to achieve the objective of security and anti-counterfeiting. The method is easy to achieve a higher anti-counterfeiting and a hidden function, and does not affect the original method of reading the QR code 10. The method of identifying hidden codes 20 of the present invention, which is based on not affecting the original method of reading the QR code 10, utilizes the camera with the high and low resolution and the appropriate threshold to achieve rapid and accurate identification of the hidden codes 20 of the QR code 10.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A QR (Quick Response) code having hidden codes, comprising a plurality of square colored message unit blocks for computer systems identification, arranged without gaps according to a predetermined rule, the hidden codes located in the colored message unit blocks, wherein the chrominance of the hidden codes is different from the chrominance of the colored message unit blocks.

2. The QR code of claim 1, wherein the colored message unit blocks comprise a plurality of white unit blocks or a plurality of black unit blocks.

3. The QR code of claim 1, wherein the square hidden codes are located at the center part of the colored message unit blocks.

4. The QR code of claim 1, wherein an area of each the hidden code is one-ninth of an area of each the colored message unit block.

5. A method of forming hidden codes, the method comprising the steps of:
providing a Quick Response (QR) code, the QR code comprising a plurality of square colored message unit blocks for computer systems identification, arranged without gaps according to a predetermined rule; and
setting a plurality of smaller colored message unit blocks for computer systems identification in the colored message unit blocks, the smaller colored message unit blocks forming the hidden codes, wherein the chrominance of the smaller colored message unit blocks is different from the chrominance of the colored message unit blocks.

6. The method of claim 5, wherein the colored message unit blocks comprise a plurality of white unit blocks or a plurality of black unit blocks.

7. The method of claim 5, wherein the square hidden codes are located at the center part of the colored message unit blocks.

8. The method of claim 5, wherein an area of each of the hidden code is one-ninth of an area of each of the colored message unit block.

9. A method of identifying hidden codes, the method comprising the steps of:
switching a resolution of a camera and selecting the same zone for each of colored message unit blocks of a Quick Response (QR) code to acquire an image information in the zones via a high resolution and a low resolution;
analyzing a mean value of pixels of the acquired image information on each of the colored message unit blocks; and
setting a threshold to identify the hidden codes, wherein the mean value lower than the threshold is assessed as 0, and greater than the threshold value is assessed as 1.
